(19) United States
(12) Patent Application Publication
(10) Pub. No.: US 2011/0241243 A1
(43) Pub. Date: Oct. 6, 2011

(54) AUTOMATED ASSEMBLY METHODS AND SYSTEMS FOR MOLDED HOUSINGS

(75) Inventor: Gerry Wootton, Cambridge (CA)

(73) Assignee: ATS Automation Tooling Systems Inc., Cambridge (CA)

(21) Appl. No.: 13/077,697

(22) Filed: Mar. 31, 2011

Related U.S. Application Data
(60) Provisional application No. 61/319,725, filed on Mar. 31, 2010.

(51) Int. Cl. B29C 39/10; B29C 71/00

(52) U.S. Cl. 264/132; 264/275; 425/110

(57) ABSTRACT

A system and method for producing molded parts with a marking component comprising: providing an insert tape comprising an insert portion configured to act as the marking component and a web portion; and molding a part around the insert tape such that the insert portion is exposed and such that the web portion acts as a carrier for the molded part in an automated process.

### RELATED APPLICATIONS

This patent application claims priority on U.S. Provisional Patent Application 61/319,725 filed Mar. 31, 2010, which is hereby incorporated by reference.

### FIELD

The present document relates generally to an automated assembly method and system. More particularly, the present document relates to the design, manufacture and application of a molded housing with label and other assembled components designed for high-volume automated production.

### BACKGROUND

While this document relates generally to molded housings, the description uses an example of a back box for a photovoltaic module to illustrate some of the aspects of the improved assembly methods and systems for molded housings.

With continuing emphasis placed on renewable energy sources, photovoltaic energy has become increasingly popular. A typical photovoltaic (“PV”) module consists of a window material to which a matrix of solar cells has been applied (laminated or deposited) with internal connections completed by a bus elements, typically flat wire or ribbon wire, all of which is covered by a back sheet material. In addition, a PV module will also include at least one junction box or back box allowing an electrical connection to the bus elements.

A back box for a PV module typically includes a housing or enclosure, which is bonded to a module to enclose the electrical connections to its internal circuits. In some cases, the housing is closed while in others the housing may be an open frame that is fastened to the module to which a lid is subsequently applied. In still other cases, the housing may be an assembly composed of several enclosure components. Conventionally, the back box enclosures are produced as individual molded parts, which are manually loaded into the assembly equipment or bulk fed by using a vibratory in-line or bowl feeder or other means.

There are many products, including photovoltaic modules, where a long lasting marking is required. The importance of the marking is often due to health or safety issues. The environment in which the product is used along with working life of the product may affect the life of the marking. Many products require that a user or consumer have certain information about the product over its working lifetime and ideally the user or consumer should be able to easily view this information. Labeling for molded parts may, in some cases, be imparted by the mold itself; however, the molded inscriptions may be difficult to read because they are typically the same color as the molded material, which for back boxes is typically black. Label stickers may also be used but may not be a suitable alternative as they may not survive the environmental conditions and may be removed or peeled off.

One particular example of where such information may be required is for photovoltaic (solar) modules. Photovoltaic module labeling must include information that is specific to each module based on performance test results and other data such as cell classification. Required information typically includes the following: operating voltage rating, maximum current (fuse) rating, performance parameters (Voc, Isc, Pmax) and test condition (STC), place of manufacture, certification (if any), electrical hazard warning, hazardous material content (if any), instructions for safe disposal or recycling (if any). Some of the necessary information can be manufacturer specific, product or model specific, batch specific or unit specific.

In some situations, it is a requirement that some graphical information, particularly hazard warnings, operating voltages and fuse ratings be clearly legible. In some cases there is also a preferred color scheme for this information, in which case, marking directly on the back box may not be a suitable solution and an additional label must be applied to the back box assembly or elsewhere on the module, adding additional components and process steps to the module manufacturing process.

With any label containing important information applied to a photovoltaic module, there is a need for these labels to remain legible and complete during the service lifetime of the module, which may be a significant length of time, possibly upwards of 25 years.

One common way to produce a markable label is to compose the label stock from layers of different colors; some commercially available materials have been optimized for laser ablation to facilitate marking. Since carbon is fade resistant, marking by simply selectively charring the base material is also an option. Yet another option is to protect a label with a transparent or translucent material, which has a UV blocking property, thereby improving the fade resistance of the underlying pigments. This material is commonly referred to as an overlam in the converting industry. Similarly, a transparent or translucent film may be applied to convey greater chemical resistance to the underlying material. Materials composed of several layers are generally formed by thermal or chemical bonding in order to achieve maximum durability. Labels may be attached by means of a specialty adhesive; however, permanent labels are preferably attached by fasteners, a method that is only appropriate for relatively heavy metal or plastic base material or thermal bonding. In all of these examples, the bill of materials is increased and assembly processes can become more complex,

In order to minimize cost and complexity of PV module assembly, it is desirable to provide back box housings, which incorporate high contrast graphical information and that are suitable for marking during the production process; consequently.

### SUMMARY

The present document describes methods and systems for assembly of a housing that are intended to overcome at least some of the deficiencies in conventional methods and systems.

In one aspect, there is provided a method for producing molded objects to include an appropriate insert that provides an area of high contrast and durable labeling suitable for marking by engraving or laser marking.

In a further aspect, there is provided a method of producing molded parts that may consists of producing an insert, applying graphical or written information to the insert, and molding the part around the insert material such that a portion of the insert is exposed, wherein the insert is configured such that it may further act as a carrier for the molded parts in a reel-to-reel process.

In a particular case, the insert material may provide a continuous web which provides the function of automatic unloading of mold cavities with transport to post processing operations without the need for pick and place tooling.

In another particular case, the insert may be marked with additional information following production of the molded part and during a product manufacturing process that makes use of the molded part.

In another case, the insert material may provide a web for feeding of molded objects into an automated assembly machine using a conventional tape and reel feeding system wherein individual molded parts are separated from the web by an excise tool after molding and prior to assembly into a product.

In some cases, there may be features in parts of the web which are not part of the finished molded object which may be used to index and accurately position the insert material and/or molded part (e.g. back box enclosure) during processing such as sprocket holes, index marks or notches, etc.

According to one aspect herein, there is provided a method for producing molded parts with a marking component comprising: providing an insert tape comprising an insert portion configured to act as the marking component and a web portion; and molding a part around the insert tape such that the insert portion is exposed and such that the web portion acts as a carrier for the molded part in an automated process.

In a particular case, the method may further comprise applying markings to the insert portion. In particular, the markings may comprise graphical or written information. Further, the applying markings may occur, at least in part, following production of the molded part and during a product manufacturing process which makes use of the molded part.

In another particular case, the insert material may comprise a web for feeding the molded parts into an automated assembly machine using a conventional tape and reel feeding system wherein individual molded parts are separated from the web by an excise tool after molding and prior to assembly into a product. In this case, the features of the web which are not part of the finished molded part may be used to index and accurately position the insert material or the molded part during processing. Further, the features of the web may be sprocket holes.

In yet another particular case, the insert material may be an insert tape.

In still yet another particular case, the molded part may be a back box designed for a photovoltaic module.

According to another aspect herein, there is provided a system for producing molded parts comprising: an insert feeding device configured to feed inset material, wherein the insert material is configured to display graphical or written information on an insert portion of the insert material; and a molding device configured to mold a part around the insert material such that the insert portion remains exposed and such that at least a portion of the remainder of the insert material acts as a carrier for the molded part in an automated process.

In a particular case, the insert material may comprise: a base material; and a contrasting material applied to the base material, wherein the contrasting material is used for marking the graphical or written information.

In another particular case, the insert material may further comprise a backer tape configured to support and protect the insert material.

In still another particular case, the insert material may comprise a web for feeding the molded parts into an automated assembly machine using a conventional tape and reel feeding system wherein individual molded parts are separated from the web by an excise tool after molding and prior to assembly into a product.

In yet another particular case, the molded part may be a back box for a photovoltaic module.

The system and method herein is intended to reduce the cost of manufacture for the molded part or object itself and to also reduce the cost of manufacture of an end product that incorporates the molded part by simplifying the feeding of the molded part, reducing the frequency of operator attendance and reducing any need for a separate label or label creation process. The system and method herein is also intended to provide improved labeling on back box housings or enclosures that provides high contrast markings and/or graphic details. The system and method is also intended to provide a means of high-speed loading, unloading and handling during the molding process.

Other aspects and features will become apparent to those ordinarily skilled in the art upon review of the following description of specific embodiments in conjunction with the accompanying figures.

### BRIEF DESCRIPTION OF FIGURES

Embodiments of the present invention will now be described, by way of example only, with reference to the attached Figures, wherein:

FIG. 1A illustrates an insert tape with over-molded parts;

FIG. 1B illustrates a finished part excised from the tape of FIG. 1A;

FIG. 2 shows the construction of insert tape according to one embodiment;

FIG. 3A illustrates insert tape with sprocket;

FIG. 3B illustrates insert tape with index marker;

FIG. 3C illustrates insert segmented on insert tape;

FIG. 3D illustrates insert floating on insert tape;

FIG. 3E illustrates insert floating on backer tape;

FIG. 3F illustrates a segmented insert;

FIG. 4 illustrates a mold tooling arrangement;

FIG. 5 illustrates a tape handler for removing backer tape;

FIG. 6 illustrates an excise and re-pack handler in the molding operation;

FIG. 7 illustrates a laser maker station according to one embodiment;

FIG. 8 illustrates a laser printer shown with optional overlam application;

FIG. 9 illustrates a post molding laser marking according to one embodiment;

FIG. 10 illustrates a pre-assembly laser marking according to an alternative embodiment;

FIG. 11 illustrates a peel and place feeding;

FIG. 12 illustrates an excise and place feeding;

FIG. 13 shows an example of insert label marking;

FIG. 14 illustrates an example of a multi-cavity molding process in plan view; and

FIG. 15 shows a flow diagram of an automated manufacture and assembly method of a back box housing according to one embodiment.

### DETAILED DESCRIPTION

Although this document focuses on methods and systems for automating and marking back boxes and other components of photovoltaic modules, the general steps for automating and marking a production component would be transferable to other molded plastic components where there is a need for automated assembly and including a need for high-contrast marking. The use and description of the back box is for example purposes only and the document and use of these methods should not be considered to be limited to this application.

Based on the discussion in the background, there is a need to have a back box and an assembly method that is more suitable to high-speed automation, for example, using components that are suitable for bulk feeding and are automation friendly. There is a further need to develop a back box with reduced material costs and overall assembly cost.

In order to produce back box enclosures with the desired features economically and with lower labor input, a back box enclosure produced by an insert molding process is desirable. Further, in order to produce the back box enclosures economically, that is, to minimize material handling and labor during manufacture and assembly as well as to facilitate automated feeding, a back box enclosure designed to be supplied in a tape format is desirable. It will be understood that the plastic molded housing described in this document may be a back box enclosure, an open enclosure or a lid (sometimes referred to as a “housing” or “back box housing”), which is a component of a back-box assembly for a photovoltaic module. In the embodiments below, this molded back box enclosure and/or lid is insert molded onto a linear material or tape, where the insert material may provide a substrate for high contrast labeling and marking and may also provide the ability of handling and feeding the molded parts during processing.

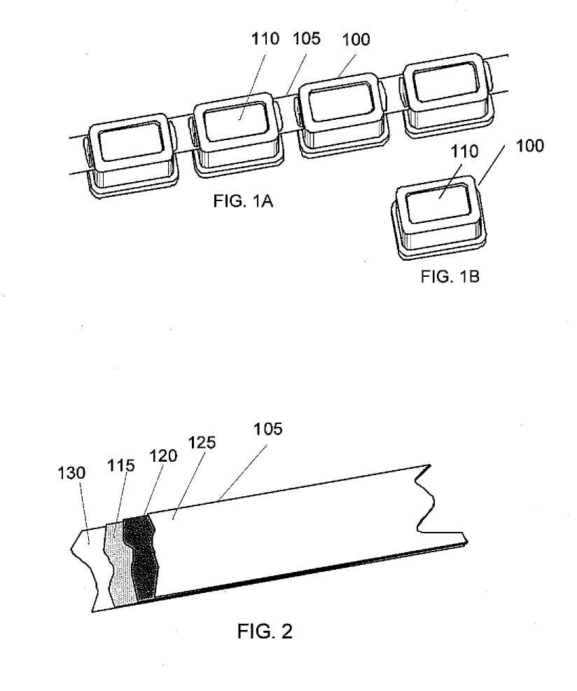

FIG. 1A illustrates an example of a series of molded housings (100), which may be solar module back box enclosures or lids. The molded housings (100) in FIG. 1A are presented in a tape format using an insert tape (105), which enables tape and reel or web feeding during the production and feeding of the molded housings (100). During photovoltaic module assembly, an exposed area (110) (sometimes called an “insert” or “insert portion” of the insert tape (105) may be used as a product label. FIG. 1B illustrates a back box housing, after the housing has been separated by removing a portion of the insert tape (105).

While the material for the insert portion may generally be in the form of the insert tape (105), the insert tape (105) may not necessarily be composed of the insert material.

Inserts may alternatively be carried on a support tape (not shown), which facilitates web handling. This may be advantageous in the case were inserts are substantially rigid or insert material is costly, in which case the support tape provides the web property for carrying the molded housings (100) and inserts (110).

FIG. 2 illustrates the general composition of an example of the insert tape (105), which may be composed of a base material (115) and a contrasting material (120) applied to the base material (115). The contrasting material (120) is used for marking and could be a film, a surface treatment, printing ink or other suitable material. The tape may also contain an optional overlaminate or overlam (125), which may be a transparent or translucent material that provides environmental protection for other layers. The insert tape (105) may be further supported and/or protected by a backer tape (130).

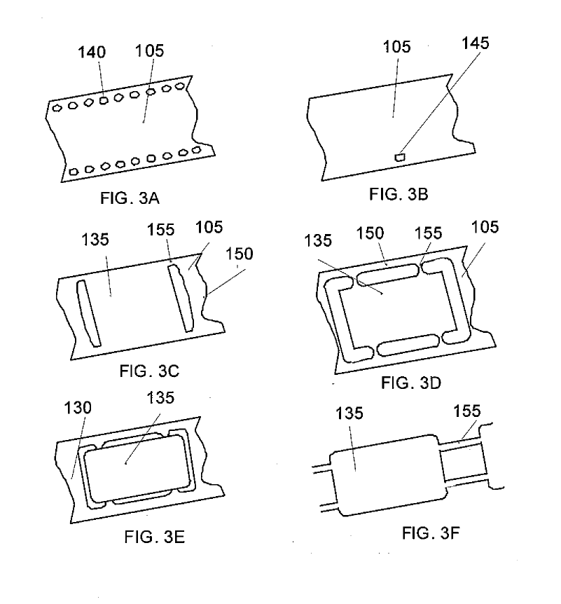

FIGS. 3A to 3F illustrate a number of indexing, features that may be formed into the insert tape (105) to facilitate feeding and processing of the molded product. FIG. 3A illustrates sprocket holes (140) formed into the insert tape (105) that may be used for tractor feeding. The sprocket holes (140) may provide positive and relatively precise web positioning for the insert tape (105). FIG. 3B illustrates an index mark (145) formed into the insert tape (105). The index mark (145) may provide a simple way of positioning the insert tape (105) to individual frames. FIG. 3C illustrates an insert portion (135) of a insert tape (105) segmented within the insert tape (105) where a continuous tape is maintained by remaining links (155) connecting the label portion (135) to scrap tape (150). FIG. 3D illustrates an alternative embodiment of label portion (135) of the insert tape (105). The insert portion (135) may be connected to the main body of the insert tape (105) by links (155) with scrap tape (150) surrounding the insert portion. FIG. 3E provides a further embodiment, where the label portion (135) is supported by a backer tape (130). The backer tape (130) may be formed to support the label portion (135), sometimes called “insert, which has been placed onto the backer tape (130) or formed by die-cutting and peeling or other tape conversion operation. FIG. 3F illustrates yet another possible configuration of the insert tape (105), which has been formed so that insert portions (135) are connected by links (155), which may be of the same material as the insert portions (135) or may be backer tape or the like. The indexing and web features of FIGS. 3A to 3F may be adapted to be used by a web indexing device (160) as described in detail below.

The insert tape (105), as shown in FIGS. 2 and 3A to 3F, may be any one of a number of flexible materials that can at least be marked or imprinted during an assembly process. There are a number of label materials that have good weatherability and are suitable for making outdoor labels including polyester, aluminum and titanium. Contrasting materials with good fade resistance include surface treatments with intrinsic color and certain pigments—lamp black being the most common but including several suspended metal particles or metal oxides (generally silver, gold, bronze, white or black and occasionally green or red). If imprinting is used there are a few inks with diffusion pigments that may be suitable; however, for the most part thermal transfer inks are more durable and available with a selection of fade resistant pigments. Screen or stencil printing may be an option that enables the use of enamels with fade resistant pigments.

There are several alternative materials for the insert tape (105) shown in FIG. 2, which can be marked by modification of the material by laser marking or similar means resulting in a contrasting coloration such as polymer materials that can be carbonized or reformulated or titanium which can be made to take on various colorations through surface modification, primarily oxidation to a known depth. Alternatively, the insert tape (105) may be composed of a substrate with additional contrasting layers, the top of which may be marked by removing this material through engraving, laser marking or other means such as multi-layer polymer tape, anodized aluminum (preferably with high-contrast anodizing such as red, blue or black), enameled metal foil, polymer tape, which may be imprinted with thermal transfer ink, or other similar material.

Label marking for durable labels generally consists of either modifying or removing material. Common methods of modifying the material include laser marking systems and hot-iron systems; laser marking systems are generally preferred due to speed and dexterity. Material may be removed by engraving using a hot iron, ultrasonic engraving tool or router or by laser ablation using a laser marking system; laser marking is preferred due to speed and dexterity. These methods and others for production of durable labels for various durable products are known. Inkjet printing, stamp printing etc. are generally less suitable since even diffusion inks that chemically bond themselves into the label stock typically do not demonstrate weatherability in excess of 25 years.

When layers are applied to the base material (115), they may be patterned to provide graphic content by applying them through an imprinting method or engraving, die cutting or etching process after application and during the production of the insert tape (105). Preferably, any material that will be exposed to the environment should have a high degree of weatherability and fade resistance; however, the insert tape (105) may be further protected by an overlam (125) composed of a translucent or transparent material that provides additional weatherability or fade resistance, for example, Lexan™ and other Ultraviolet (UV) resistant or UV blocking polymers. An additional alternative is a material that contrasts with the back box enclosure material, which is marked by removal of that material to expose the back box enclosure material or alternatively is over-molded and marked by removing the over-molded back box enclosure material resulting in a high contrast durable marking.

Layered polymer materials will typically provide a limited color palette depending on the number and color of layers of material from which the insert material is composed; however, there are a number of polymer tapes that are commercially available that are durable and fade resistant and have been optimized for laser marking. Anodized aluminum foils provide a binary color scheme but with a broad range of colors available for commercial anodizing many of which are fade resistant and may be fortified by Teflon™ impregnation, carbo-nitriding or other surface preparation. Similarly, polymers that are imprinted by denaturing or carbonization may be limited to a binary color scheme. Enameled material consists commonly of a single layer of enamel resulting in a binary color scheme although additional layers can be applied—monochrome and multi-colored enameled metal labels are commonly used for durable labeling on electrical equipment. Titanium and some other metals can be indelibly marked with a variety of colors resulting from controlled surface modification essentially resulting in a classic optical interference filter (butterfly effect). Any of these materials generally have the capability of permitting high contrast and highly weather resistant labeling.

It should be noted that bulk polymers, inks or paints that rely on a pigment for their basic color are preferably restricted to available colors where the pigment is fade resistant. Alternatively, a thin layer of polycarbonate or other similar transparent material with UV blocking characteristics combined with good weatherability may be used to improve the fade-resistance of the pigment used.

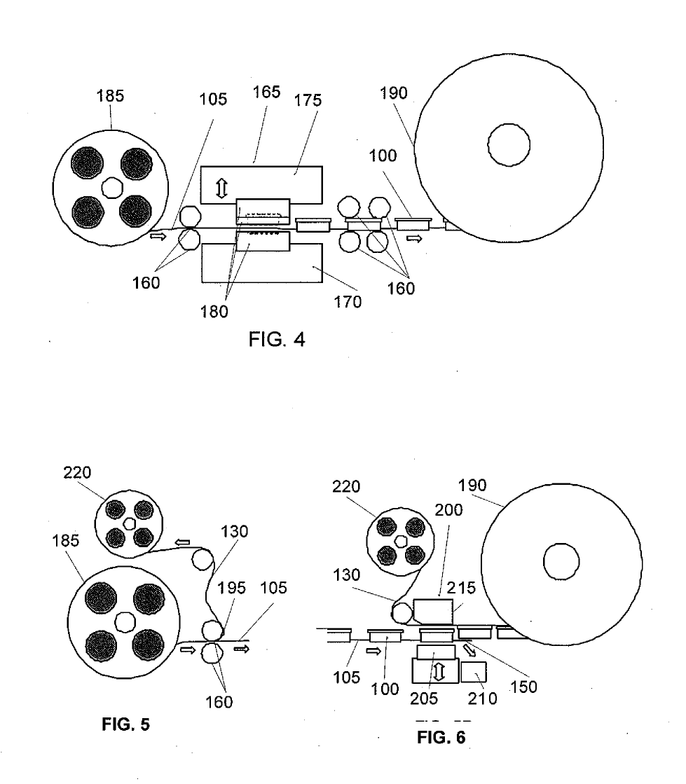

FIGS. 4 to 12 illustrate example embodiments of assembly and manufacture systems for automating the manufacture and application of a molded plastic housing with label when formed as noted above; FIG. 4 illustrates an example reel-to-reel molding process system, where insert tape (105) may be fed from supply reel (185) through a molding press (165) consisting of upper (175) and lower (170) platens with mold parts (180) by web indexing devices (160). Molded housings (100) are formed around the insert portion (135) of the insert tape (105), where the insert tape (105) provides a carrier for the molded housings (100), which are collected onto a reel (190) that is used to store, transfer and feed these molded parts.

In a particular case, the molding process system may be selected such that the insert tape (105) remains connected during formation of the molded housings (100) and the insert tape (105) then acts as a means for feeding the molded housings from a tape reel and/or bandolier without any additional packing materials. The molding process systems may further allow for high-speed loading, unloading and handling during the molding process, which may result in high throughput and minimal handling. Additionally, some of the insert tape (105) may remain outside of the mold cavity during the molding operation. Higher throughput and reduced handling may result in a reduction in unit cost.

FIGS. 5 and 6 illustrate some additional processing options that could be added to the molding process system. FIG. 5 illustrates an optional process of a tape handler provided for removing backing tape. The insert tape (105) with a backer tape (130) may be supplied on a reel (185), which supports and protects the insert material. The backer tape (130) may be removed from the tape by a peeling device (195) and collected onto a take-up reel (220) while the insert tape (105) is being fed by indexing devices (160).

FIG. 6 illustrates an optional process including an excise and re-pack handler for use in the molding operation. The molded housing (100) carried on the insert tape (105) may be excised from the insert tape (105) following the molding operation by excise press (200) consisting of a cutting die (205), a press platen (215) with a discard bin to remove scrap tape (150). In this case, the molded housings (100) may be transferred to a new backer tape (130), which is fed from a supply reel (220). The resulting web (tape (130) and housings (100) being collected onto a take-up reel (190) that is used to store, transfer and feed the molded housings (100).

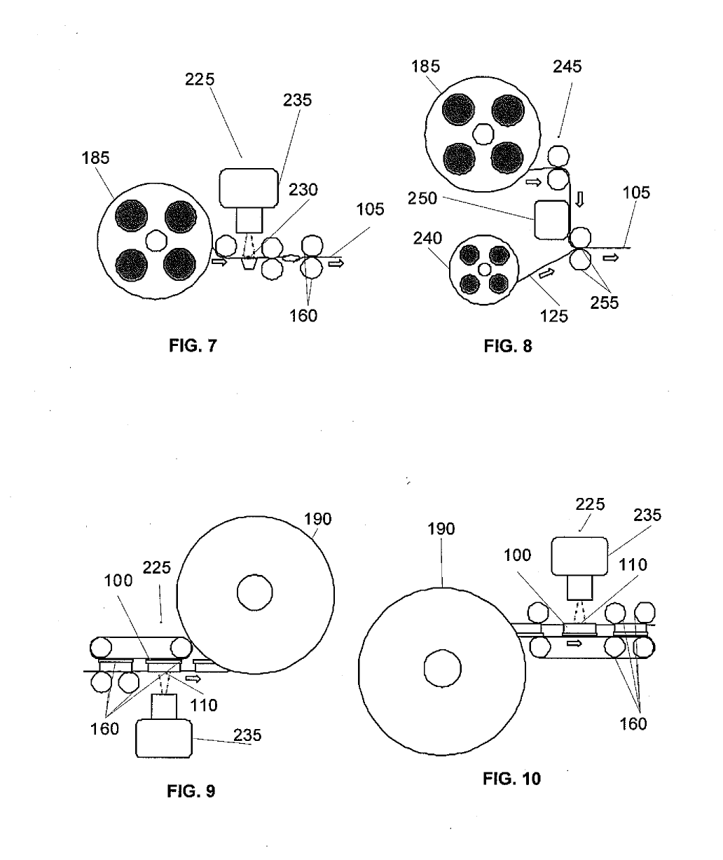

FIGS. 7 and 8 illustrate systems for marking the insert tape (105). FIG. 7 illustrates a laser marking and/or machining operation at a laser marking station (225) that processes insert tape (105) fed from a supply reel (185). The laser marking station (225) may be supported on a laser chuck (230) and machined by a laser system (235), while being web fed by web indexing devices (160).

FIG. 8 illustrates an alternative to the laser marking station (225), a printing station (245) that is adapted to apply markings to the insert tape (105). The printing station (245) may be fed from reel (185) past a printer head (250) with an overlam (125) fed from reel (240) being subsequently laminated to the insert tape (105) by nip rollers (255).

FIGS. 9 and 10 illustrate alternative laser marking stations for marking the exposed area (110) of the insert tape (105). FIG. 9 illustrates an example of laser marking the exposed area (110) embedded into the molded housing (100). The exposed area (110) may be marked in a laser marking station (225) by a laser marking head (235) while being fed by web indexing devices (160) and collected onto a reel (190). FIG. 10 illustrates an example of laser marking while pulling the insert tape (105) carrying molded housing (100) from a supply reel (190), then marking the exposed area (110) of the insert tape (105) in a laser marking station (225). The laser marking station (225) may contain a laser marking head (235) and may feed the insert tape (105) by means of web indexing devices (160).

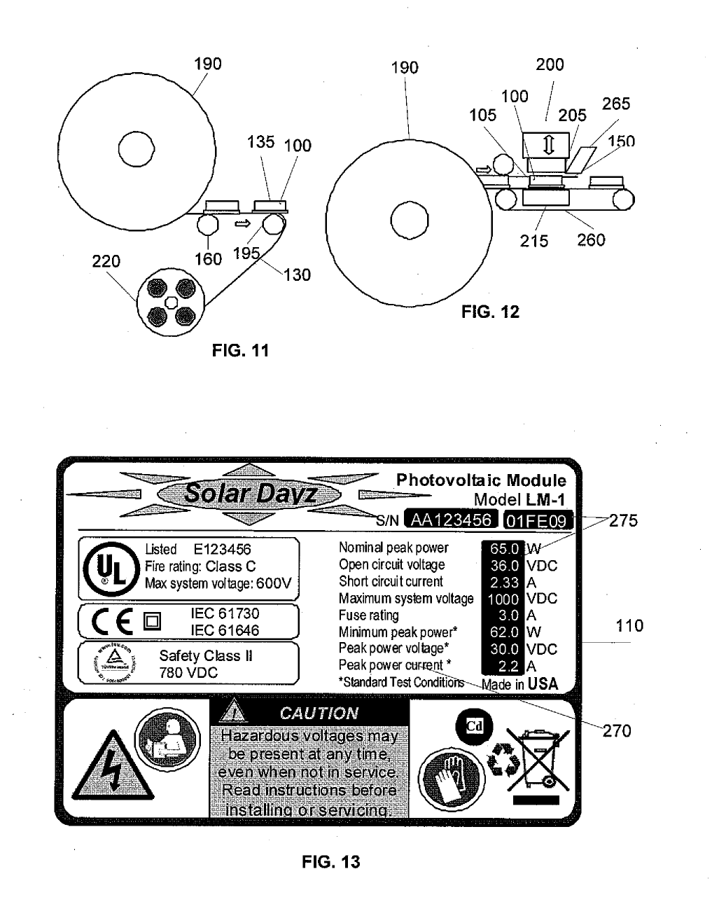

FIGS. 11 and 12 illustrate part feeding systems that may be used during an assembly process. FIG. 11 illustrates a part feeding system, where molded housings (100) with label area (135) are carried on a backer tape (130) that is fed from a supply reel (190) by means of web indexing devices (160). The molded housings (100) are then passed over a peeling device (195) where molded parts are separated from the backer tape while being acquired by pick & place tooling (not shown). The backer tape (130) may be collected onto a take-up reel (220).

FIG. 12 illustrates an alternative part feeding system, wherein molded housings (100) are carried on the insert tape (105) and are fed from a supply reel (190) through an excise press (200) consisting of an excise die (205) and a press platen (215). Insert tape (105) is excised to separate the molded housing (100) from the insert tape (105) with scrap tape (150) being carried away by a tape removal device (265), while the individualized part is shuttled to a pick up position by a belt transfer (260). Alternatively, the press platen may be used for shuttling to the pick position.

FIG. 13 illustrates an example of label content appearing on the exposed area (110) of the insert tape (105), which includes both fixed content (270) and dynamic content (275), for example, serial number, measured performance data, etc. Some of the standard cautionary and advisory logotypes are preferably reproduced in color, although, the use of high-contrast black & white is permitted in some jurisdictions.

Since it is necessary to provide some content that is indicative of performance, final marking is generally applied after final testing of the completed product. It may be advantageous to have basic graphics, particularly that which is of commercial value, and/or label content for which there is a statutory color scheme, such as hazard warnings and recycling marks, applied at an early stage in order to facilitate graphic quality and impact. It may also be advantageous to minimize the amount of marking during product manufacturing if it impairs production rate. On the other hand, it may be desirable to perform the majority of marking late in the process on high-mix production lines in order to minimize inventory and product changeover time.

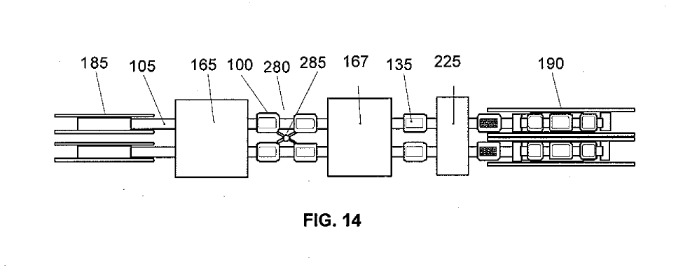

FIG. 14 illustrates an example of a multi-cavity molding process feeding multiple webs of insert tape material (105) fed from supply reels (185) through a multi-cavity mold in insert mold press (165) producing multiple molded parts (100) connected temporarily by excess molded material (285). Molded material is allowed to cool in cool-down zone (280) before trimming away excess molded material (285) in a trimming press (167) resulting in multiple webs of molded parts (100), which are optionally marked in laser marking station (225) before being collected onto tape reels (190).

The insert may include information that would be considered important with regard to the unit and may include safety and recycling information. Since the information may be marked during the processing of the object, the information may be modified dynamically as required during manufacturing and/or quality control.

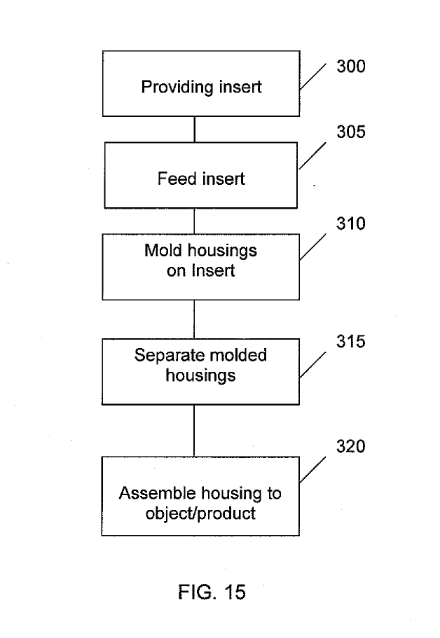

As shown in FIG. 15, a method for manufacture and assembling molding housings with labels consists of: providing insert tape (105) (300); feeding the insert tape (105) into a molding press (305); molding and processing of the molded housing (100) onto the insert tape (105) (310); separating the housings (100) and inserts from the insert tape (105) (315); and assembling the housings (100) and other components onto a part such as a PV module (320). It will be understood that each of these stages may be performed as a separate action with storage in between or may be performed on an assembly line without storage in between operations.

One of skill in the art will understand that the marking of the insert portion of the insert tape (105) may take place during any of these steps or after the part is assembled or at various points during the automated process.

Preferably, composition of the insert from stock materials, shaping and basic marking would be performed using standard conversion tooling. This may be advantageous since the process is generally fast and efficient and the standard tooling is modular and configurable; however, as a general design consideration, the insert feature size and pitch should be made to be compatible with the modularity of standard conversion equipment.

In another embodiment, the method may include: providing the insert tape (105) in tape-and-reel format in a normal conversion process such as performed by commercial converters where the various layers of materials are combined, laminated, die-cut, trimmed, printed or marked and formed; feeding the insert tape (105) through a molding press such that the insert tape (105) is aligned to features in the die cavity on each index; over-molding the structure of the molded housing (100); carrying the insert tape (105) or web out of the mold press and collecting the result onto a reel; subsequently placing the reel into an assembly machine, web feeding the insert tape (105) with housing (100) into an excise fixture where an individual housing is separated from the web by removing excess insert material and optionally trimming excess molded material (285), then assembled onto a PV module; and then, after completing assembly of the module and performing an end-of-line functional test, laser marking additional information onto the label.

Alternatively, the insert tape (105) may remain essentially un-patterned (blank) until loaded into the module assembly process (320), where the insert tape (105) may be imprinted with label information while web feeding the molded housings on insert tape into the assembly process (320). At this stage, laser marking may be an advantageous method of performing this operation. Alternatively, printing with hot melt ink could be applied; in this instance, it would be likely that an overlam of polycarbonate or similar material would be applied for enhanced weatherability.

In a further alternative, the excise operation may be performed immediately following the molding operation (310), at which time the molded housing may be engaged with a new backer tape (130) using a temporary adhesive to enable further web processing. This may be preferred if the insert tape (105) is relatively stiff as it may permit greater linear density of housings when wound onto a reel. Greater linear density may reduce the amount of excise and trim tooling required in the overall process since the molding process may have much shorter cycle time than the module assembly process (320) and greatly simplifies the assembly machine process and tooling.

In another alternative the excise operation may be combined with trimming of flash and other excess molded material. This may be advantageous when the molded housings may be a commodity that changes hands during the process sequence as it relieves the end user of the need for custom tooling. In this case, the assembly machine would simply peel individual molded housings (100) off of the backing tape (130) in an analogous fashion to many labeling machines.

According to one embodiment, a method of marking is provided including having a label portion (135), which may be formed from an insert tape (105) that may have been imprinted or marked during its manufacture process (300), by a converting process. For example, optionally marking at least a portion of the insert tape (105) before feeding the insert into a molding system (305) and then molding (310) the housing (100) to include the insert tape (105) in such a way that the marked or markable portion (110) remains visible. It is also contemplated that the insert tape (105) may be marked subsequent to molding the housing (100) and/or marking or completing the marking of the insert portion of the insert tape (105) after assembly of the molded part to a module.

In particular, the insert tape (105) may be provided via a die-cut or punched tape assembly that may also act as a carrier tape permitting the insert tape (105) to be reel fed, which may be suitable for an automated process. If any support legs and extra insert material is used, it may be excised by a cutting die, blade, router or other mechanical means when it becomes necessary to separate the molded part from the continuous web of molded housings (315). In general, the insert tape (105) may be shaped as needed during its composition: specialized manufacturers normally identified as ‘converters’ typically use rotary die cutting and/or laser cutting and are adept at cutting and laminating flat shapes of all kinds.

The insert tape (105) may be marked at any or each of a number of process stages and stations as some of the information is relatively static and other information is dynamic. The content of the marking may include information generic to the manufacturer, specific to the product line, specific to the product, specific to the production lot and specific to the individual unit. Insert tapes (105) may be patterned when the basic material is converted into feedstock prior to the molding process. Insert tapes (105) may be patterned during web handling into or out of the molding process (310). Insert tapes (105) may be engraved or heat stamped during the molding process (310). Insert tapes (105) may be further marked during web handling in the module assembly process (320). Alternatively, insert tapes (105) may be marked after being assembled to the module.

During the feeding process (305), the insert will generally be in the form of an insert tape, although, it may not need to be entirely flat, which allows it to be supplied on a reel or in a bandolier carton. The insert tape (105) may be fed (305) through the mold presses to prepare for the molding process (310). The insert tape (105) may be indexed in between each molding press cycle. This molding process (310) serves the dual purpose of placing a fresh insert into the mold while carrying away the previously molded housing.

During the molding process (310), the hosing (100) is molded around the insert tape (105) in such a way that the insert tape (105) is firmly attached to the housing (100) but also such that portions (110) of the insert tape (105) are visible as needed. Normally, labels are fastened to the product by adhesive, rivets or screws; however, in this scheme, over-molding and/or thermal bonding can provide the required retention.

During the molding process (310), it is typical for there to be multiple cavities in the mold to increase production rate, which, when ejected from the mold, are joined by flow features that are removed to separate the parts. Any flash that forms at parting lines may also need to be removed. Excess material may be removed by means of a trimming die or other cutting operation that, in an automated process, provides automatic alignment of the ejected material. It is desirable to provide the ability to automatically carry parts from the mold to the trimming operation and subsequently to a package for storage and handling with the least amount of tooling possible. This ability will maximize production rate while minimizing tooling cost. It may also be desirable to provide a method of handling the parts through a cool-down process before trimming or packaging. In most cases, robotic handlers or manual labor can provide this handling.

After molding (310), the insert tape (105) with molded housings (100) may be collected onto a take-up reel or other bulk packaging for ease of shipping and handling. Depending on the mold design, one or more molded housings (100) may be formed at one time either multiples on one insert tape (105) or in parallel on several adjacent insert tapes or both together.

An additional advantage is that the freshly molded housings (100) may be suspended by the insert tape (105) for a period of time prior to reeling, which provides an opportunity for a cool-down zone outside of the mold. The cool down period may further expedite the molding process (310). At this stage, there may also be a process to excise or remove flash and other excess plastic molded material (285). Many excising processes are known including die cutting, blade running, hot wire, laser cutting, kiss cutting and other methods. One advanced method is masked ablation, using an excimer laser or lamp, which is particularly advantageous when stripping plastic from metal, which could be applied if the insert tape is metallic. This process is intended to allow large numbers of housings (100) such as back box enclosures to be produced rapidly with a minimum of material handling which helps to produce back box enclosures at lower cost.

The insert tape (105) will normally be formed in such a way as to facilitate the separation (315) of individual molded housings (100) as needed. This approach may be used for bulk-feeding various electrical and electronic components. Individual components are excised from the insert tape (105) using a cutting mechanism such as shears, a blade, a hot knife, a cutting die, a router or a laser. The laser option may be advantageous, since it may permit separation and marking within a single operation.

While insert tape (105) will normally be handled by winding onto a reel or folded into a bandolier, it could alternatively be cut into fixed lengths that are stacked into a carton or magazine. While this method of supplying molded housings (100) to the PV module assembly process (320) is intended to be advantageous for automated assembly, it may also be advantageous in semi-automated or manual assembly processes due to the convenience of handling larger numbers of parts at the same time.

During the assembly process (320), frequent feed interruptions such as material restocking and/or operator interventions should be avoided as this reduces throughput. Also, it is desirable to minimize operator intervention in order to minimize production cost. Tape formats are commonly used to feed parts into automated processes because of the density and simple continuous feed they can provide. Additionally, feed interruptions can be mitigated by having duplicate reels with automatic tape loading, or by providing a quick splice capability or by using a web feeding method such as sprocket or capstan feeding that can tolerate tape interruptions where all of these methods are well known means of providing minimal interruption of flow in tape feeder systems.

Final preparation for assembly is preferably done in-line with the PV module assembly process (320) as this maintains the advantages of web handling of the parts as long as possible.

If the feeding is done in-line with the PV module assembly, it may reduce the time needed to complete a PV module. For example, it may be possible to complete the module with back box in the range of 15-20 seconds per module.

The methods described herein provide for a high contrast label area, which may be written or partially written during production eliminating the need for a separate molded or printed label. The use of an insert formed of these materials is intended to provide for long-life, high-contrast marking. In this way, the insert allows the marked information to be easily read and important information to be clear to anyone, as illustrated in FIG. 13.

As noted above, a particular example of where there is a need for such a marking method and system is in the marking of back boxes or junction boxes of photovoltaic modules. Photovoltaic module labeling must contain data that is specific to the module. The above method and system may be applied to the photovoltaic module labeling of the back box enclosure.

While the above descriptions refer to “molded housings’ and a ‘back box enclosure”, the same principles apply to various housings, enclosures and lids which may be used in various designs of back boxes that could be used for making electrical connections to photovoltaic modules. In one embodiment, for minimal cost, a single piece back box enclosure would be used to enclose the electrical connections; however, it is sometimes desirable to divide this enclosure into several pieces that are assembled one after another. The method of manufacture and assembly process may equally be applied to any or all of these components and particularly a lid for a back box composed of multiple molded parts.

The above descriptions refer to an insert or insert tape, which resides primarily on the top surface of the part so that it may serve the function of a label. This is advantageous for the several reasons already given; however, it may be advantageous for the insert to provide alternative or additional functionality. It may also be advantageous to have more than one insert tape be fed into the molding process. It is entirely feasible and practically possible to feed more than one such tape through the mold cavity. Alternative functional uses of the insert could include heat spreading or thermal management and/or formation of interior electrical circuit elements.

Preferably, molding of the enclosure and other related processing would be performed in a single molding machine. This may be advantageous because the molding process is likely to proceed at a cycle time that is an order of magnitude faster than module assembly, or more, and, with multiple cavities, higher throughput than module production. One molding machine can supply many production machines, broadly amortizing the cost of the mold.

While the description refers specifically to a “back box housing” and “photovoltaic module”, it applies equally to any of the molded components that are used to enclose and insulate the electrical connections of a photovoltaic module, or more generally to any junction box or similar enclosure used in similar applications requiring a weather resistant enclosure with very durable labeling and marking incorporated into any product requiring an enclosure for weather resistant electrical connections. The methods and systems may also apply to other molded objects where it is desirable to include high contrast labels with a molded plastic part through an automation process.

In the preceding description, for purposes of explanation, numerous details are set forth in order to provide a thorough understanding of the embodiments. However, it will be apparent to one skill in the art that these specific details are not necessarily required. The above-described embodiments are intended to be examples only. Those of skill in the art can effect alterations, modifications and variations to the particular embodiments without departing from the scope of the present application.

We claim:

1. A method for producing molded parts with a marking component comprising:
providing an insert tape comprising an insert portion configured to act as the marking component and a web portion;
molding a part around the insert tape such that the insert portion is exposed and such that the web portion acts as a carrier for the molded part in an automated process.

2. The method of claim 1 further comprising applying markings to the insert portion.

3. The method of claim 2 wherein the markings comprise graphical or written information.

3. The method in claim 2 wherein the applying markings occurs, at least in part, following production of the molded part and during a product manufacturing process which makes use of the molded part.

4. The method of claim 1 wherein the insert material comprises a web for feeding the molded parts into an automated assembly machine using a conventional tape and reel feeding system wherein individual molded parts are separated from the web by an excise tool after molding and prior to assembly into a product.

5. The method of claim 4 wherein features of the web which are not part of the finished molded part are used to index and accurately position the insert material or the molded part during processing.

6. The method of claim 5 wherein the features of the web are sprocket holes.

7. The method of claim 1 wherein the insert material is insert tape.

8. The method of claim 1 wherein the molded part is a back box designed for a photovoltaic module.

9. A system for producing molded parts comprising:
an insert feeding device configured to feed inset material, wherein the insert material is configured to display graphical or written information on an insert portion of the insert material; and
a molding device configured to mold a part around the insert material such that the insert portion remains exposed and such that at least a portion of the remainder of the insert material acts as a carrier for the molded part in an automated process.

10. The system of claim 9 wherein the insert material comprises:
a base material; and
a contrasting material applied to the base material, wherein the contrasting material is used for marking the graphical or written information.

11. The system of claim 9 wherein the insert material further comprises a backer tape configured to support and protect the insert material.

12. The system of claim 9 wherein the insert material comprises a web for feeding the molded parts into an automated assembly machine using a conventional tape and reel feeding system wherein individual molded parts are separated from the web by an excise tool after molding and prior to assembly into a product.

13. The system of claim 9 wherein features of the web which are not part of the finished molded part are used to index and accurately position the insert material or the molded part during processing.

14. The system of claim 9 wherein the molded part is a back box designed for a photovoltaic module.
